(19) United States
(12) Patent Application Publication
(10) Pub. No.: US 2026/0364690 A1
(43) Pub. Date: Nov. 19, 2026

(54) CUT-OFF SAW

(71) Applicant: MILWAUKEE ELECTRIC TOOL CORPORATION, Brookfield, WI (US)

(72) Inventors: Michael J. LaValley, West Allis, WI (US); Justin T. Kornely, Milwaukee, WI (US); Ryan W. Parker, Wauwatosa, WI (US)

(21) Appl. No.: 19/675,843

(22) Filed: May 13, 2026

Related U.S. Application Data
(60) Provisional application No. 63/849,165, filed on Jul. 23, 2025.
(60) Provisional application No. 63/805,538, filed on May 14, 2025.

(51) Int. Cl. B23D 45/16; B25F 5/02

(52) U.S. Cl. CPC B23D 45/16; B25F 5/02

(57) ABSTRACT

A cut-off saw may include a housing including a base upon which the cut-off saw is positionable on a horizontal support surface. A cut-off saw may include an electric motor positioned within the housing. A cut-off saw may include a support arm extending in a forward direction from the housing, the support arm including a longitudinal axis defining an oblique angle with the horizontal support surface. A cut-off saw may include a cutting wheel supported by the support arm. A cut-off saw may include a rear handle extending in a rearward direction from the housing. A cut-off saw may include a battery receptacle at least partially defined by the base and positioned behind the motor and beneath the rear handle, the battery receptacle configured to receive a battery pack.

### CROSS-REFERENCE TO RELATED APPLICATION

This application claims priority to U.S. Provisional Patent Application No. 63/849,165, filed July. 23, 2025, and U.S. Provisional Patent Application No. 63/805,538, filed May. 14, 2025, the entire contents of both of which are incorporated by reference herein.

### FIELD OF THE INVENTION

The present invention relates to power tools, and more particularly to cut-off saws.

### BACKGROUND OF THE INVENTION

Power tools such as, cut-off saws, generally have many applications. Cut-off saw can be held directly by a user for operation or supported by a cart. During operation, the cut-off saw can make precise cuts into a floor surface such as concrete or asphalt. The cut-off saw can also cut rebar, metal pipe, PVC pipe, and a wall surface.

### SUMMARY OF THE INVENTION

In some aspects, the techniques described herein relate to a cut-off saw including: a housing including a base upon which the cut-off saw is positionable on a horizontal support surface; an electric motor positioned within the housing; a support arm extending in a forward direction from the housing, the support arm including a longitudinal axis defining an oblique angle with the horizontal support surface; a cutting wheel supported by the support arm; a rear handle extending in a rearward direction from the housing; and a battery receptacle at least partially defined by the base and positioned behind the motor and beneath the rear handle, the battery receptacle configured to receive a battery pack.

In some aspects, the techniques described herein relate to a cut-off saw including: a housing; an electric motor positioned within the housing, the motor operable in a first mode and a second mode that is different than the first mode; a battery pack operable to provide electrical current to the motor; a cutting wheel driven by the motor to rotate about an axis; and a load indicator operable to switch the motor between the first mode and the second mode, the load indicator operable to detect a performance parameter of the battery pack, the motor, or both, and indicate to a user with an indication that the performance parameter is above a predetermined threshold; wherein the predetermined threshold is higher when the motor is in the first mode than when the motor is in the second mode.

In some aspects, the techniques described herein relate to a cut-off saw including: a housing including a base; an electric motor positioned within an interior of the housing; a support arm coupled to and extending from the housing in a first direction; a cutting wheel supported by the support arm; a rear handle extending from the housing in an opposite, second direction; an inlet vent defined by the housing and positioned adjacent the rear handle and in communication with the interior of the housing; an exhaust vent defined by the housing positioned adjacent the motor and in communication with the interior of the housing; and a protective plate positioned between the cutting wheel and the exhaust vent to inhibit the ingress of debris into the housing; wherein in response to the activation of the motor a cooling airflow is induced through the inlet vent, through the motor, and discharged from the exhaust vent.

In some aspects, the techniques described herein relate to a cut-off saw including: a housing; an electric motor positioned within the housing; a support arm coupled to and extending from the housing; a cutting wheel rotatably supported by the support arm about a rotation axis; and a blade guard covering a portion of an outer circumference of the cutting wheel, the blade guard including a body and a splash guard extending from the body.

In some aspects, the techniques described herein relate to a cut-off saw including: a housing; an electric motor supported within the housing, the electric motor including an output shaft; a support arm extending in a forward direction from the housing; a cutting wheel supported by the support arm; a drive assembly positioned in the support arm for transmitting torque from the motor to the cutting wheel, the drive assembly including, a drive pulley fixed to the output shaft of the motor, a driven pulley connected to the drive pulley by a belt, and a spindle fixed to the driven pulley about an axis; and a spindle lock supported on the support arm adjacent the spindle, the spindle lock moveable between a first position, in which the spindle is allowed to rotate and a second position, in which the spindle is inhibited from rotating.

In some aspects, the techniques described herein relate to a cut-off saw including: a housing; an electric motor positioned within the housing; a support arm coupled to and extending from the housing; a cutting wheel supported by the support arm and configured to rotate about a rotational axis; a blade guard supported by the support arm and covering a portion of an outer circumference of the cutting wheel, the blade guard including an upper surface defining a ridge extending circumferentially about a portion of the blade guard, the ridge being aligned with the cutting wheel to provide a sight line during a cutting operation.

In some aspects, the techniques described herein relate to a cut-off saw including: a housing; an electric motor positioned within the housing; a support arm extending from the housing; a cutting wheel supported by the support arm; a blade guard coupled to the support arm to cover a circumferential portion of the cutting wheel; a fluid distribution system operable to dispense fluid onto the cutting wheel, the fluid distribution system including a valve coupled to the housing, a nozzle coupled to the blade guard, and a supply line extending between the valve and the nozzle; and a bracket extending from the support arm through which a portion of the supply line extends to secure the supply line to the support arm.

Other aspects of the disclosure will become apparent by consideration of the detailed description and accompanying drawings.

### BRIEF DESCRIPTION OF THE DRAWINGS

FIG. 1 is a side view of a cut-off saw in accordance with an embodiment of the invention.

FIG. 2 is a perspective view of the cut-off saw of FIG. 1.

FIG. 3A is another perspective view of the cut-off saw of FIG. 1.

FIG. 3B is a partial perspective view of the cut-off saw of FIG. 1, illustrating a load indicator.

FIG. 3C is a partial perspective view of the cut-off saw of FIG. 1, illustrating a load indicator according to another embodiment of the invention.

FIG. 4A is another perspective view of the cut-off saw of FIG. 1.

FIG. 4B is a detailed view of a work light of the cut-off saw of FIG. 1.

FIG. 5 is a cross-sectional view of the cut-off saw of FIG. 1.

FIG. 6 is a perspective view of the cut-off saw of FIG. 1, illustrating a drive train.

FIG. 7 is a perspective view of a spindle lock assembly on the cut-off saw of FIG. 1.

FIG. 8 is a cross-sectional view of the spindle lock assembly of FIG. 7.

FIG. 9A is a front perspective view of the cut-off saw of FIG. 1 illustrating a splash guard.

FIG. 9B is a detailed view of the splash guard of FIG. 9A.

Before any embodiments of the disclosure are explained in detail, it is to be understood that the disclosure is not limited in its application to the details of construction and the arrangement of components set forth in the following description or illustrated in the accompanying drawings. The disclosure is capable of supporting other embodiments and of being practiced or of being carried out in various ways.

### DETAILED DESCRIPTION

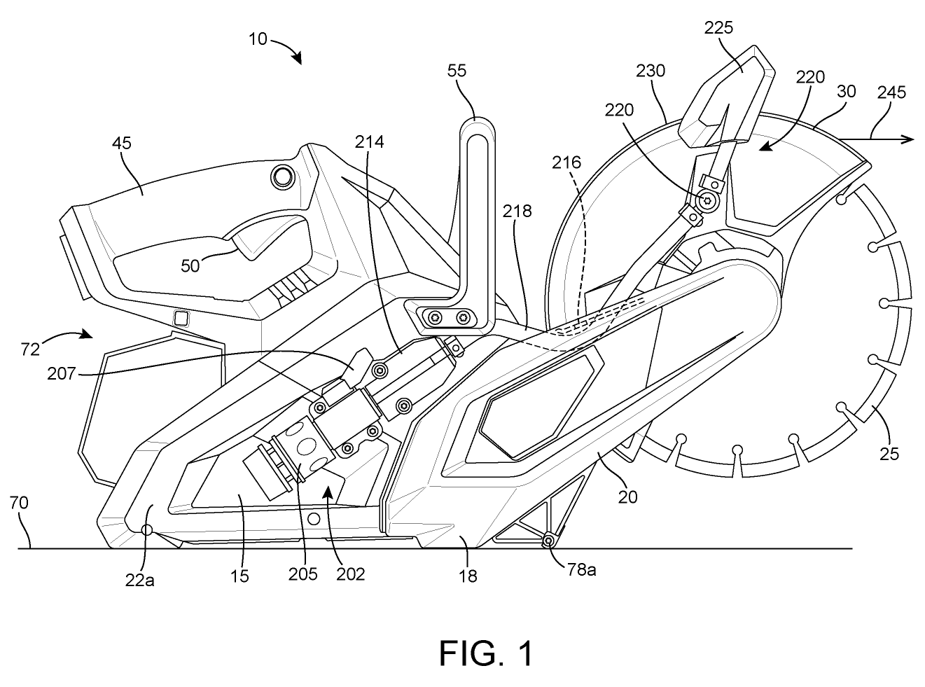

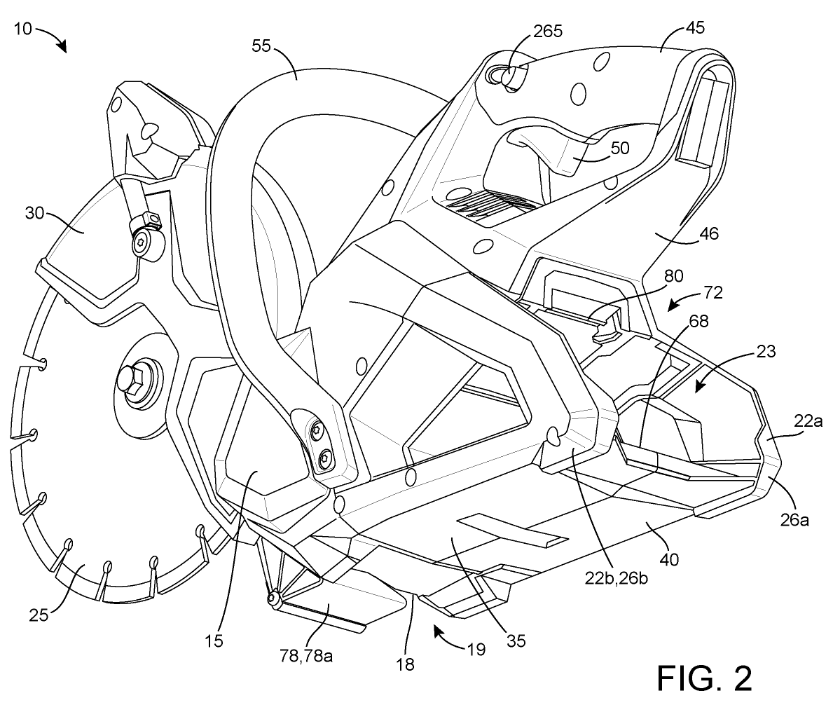

FIGS. 1-2 illustrate a handheld power tool 10, which is a cut-off saw in the illustrated embodiment. The saw 10 includes a housing 15, a support arm 20 coupled to and extending from the housing 15, a cutting wheel 25 (e.g., saw blade) carried by the support arm 20, and a guard covering a portion of the circumference of the cutting wheel 25. The cutting wheel 25 can be a blade, an abrasive disk, or any other rotatable element capable of removing material from a workpiece. In the illustrated embodiment, the cutting wheel 25 has an outer diameter less than 12 inches and greater than 6 inches. Preferably, the cutting wheel 25 has a nominal outer diameter of 9 inches. In the illustrated embodiment, the guard 30 is rotatably coupled to the support arm 20 to provide a variety of operating positions that expose different circumferential portions of the cutting wheel 25. This advantageously allows the saw 10 to be used in a variety of cutting positions.

The illustrated housing 15 is a clamshell housing having left and right cooperating halves 35, 40 (FIG. 2). A first or rear handle 45 extends from a rear portion of the housing 15 in a direction generally opposite the support arm 20. In the illustrated embodiment, the rear handle 45 is a d-shaped handle. A trigger 50 for operating the saw 10 is located on the rear handle 45. In the illustrated embodiment, the saw 10 also includes a second or forward handle 55 that wraps around an upper portion of the housing 15. The forward handle 55 and the rear handle 45 provide grip areas to facilitate two-handed operation of the saw 10.

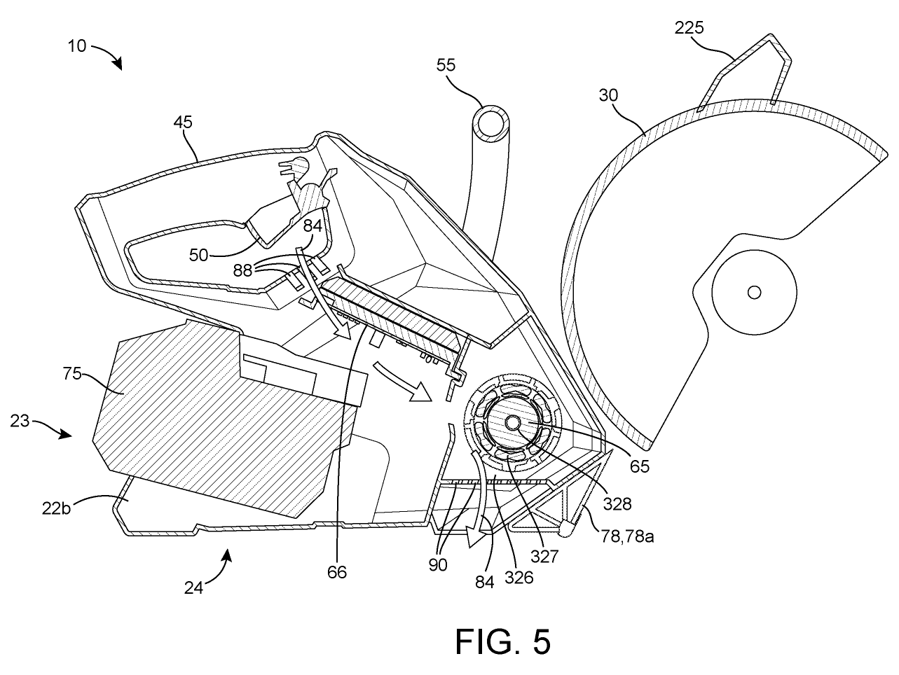

With reference to FIG. 5, the saw 10 further includes an electric motor 65 located within the housing 15 at a front, lower portion of the housing 15. The motor 65 is preferably a brushless direct-current (“BLDC”) motor. Operation of the motor 65 is governed by a motor controller on a printed circuit board 66 (“PCB”). The motor 65 includes a motor housing 326, a stator 327 supported within the motor housing 326, a rotor 328 rotatably supported within the motor housing 326, and a cooling fan (not shown) driven by the motor.

With reference back to FIG. 2, the illustrated saw 10 is a cordless electric saw and includes a battery receptacle 72 defined in the housing 15 and a battery pack 75 (FIG. 5) that provides power to the motor 65 disposed within the battery receptacle 72. In the illustrated embodiment, the battery receptacle 72 is a separate compartment from the housing 15. In some embodiments, the battery pack 75 and the motor 65 may be disposed in the same compartment and/or housing. The battery receptacle 72 is positioned below the rear handle 45 and behind the electric motor 65, at a rear portion of the housing 15. The battery receptacle 72 is on an opposite side of the motor from the support arm 20. The battery receptacle 72 is generally open to the environment and may be accessed from behind or partially from below the housing 15. Specifically, the housing 15 defines two support brackets 22a, 22b, one on each side of the battery receptacle 72, to support the saw 10 on a horizontal work surface 70 (FIG. 1) and protect the battery pack 75. In other words, the support brackets 22a, 22b each include a foot portion 26a, 26b configured to come in contact with the work surface 70 and support the saw 10. The support brackets 22a, 22b further define a bottom plate 68 that protects a bottom side of the battery receptacle 72 and the battery pack 75 when the battery pack 75 is received in the battery receptacle 72. As such, the support brackets 22a, 22b define an open rear side 23 that the battery receptacle 72 is accessible from. In addition, one the support brackets 22b includes an opening 82 that extends into the battery receptacle 72. The opening 82 facilitates heat dissipation from within the battery receptacle that accrues from the battery pack and the motor. In some embodiments, the support brackets 22a, 22b are integral with the housing 15. In other embodiments, the support brackets 22a, 22b may be coupled to the housing 15 using fasteners or the like.

The rear handle 45 further defines a handle guard 46 positioned on a bottom side of the rear handle 45 and between the support brackets 22a, 22b. Accordingly, the handle guard 46 is positioned adjacent a top side of the battery pack 75 to further protect the battery pack 75. Additionally, the handle guard 46 extends further rearwards from the housing 15 than the brackets 22a, 22b and battery receptacle 72 to advantageously protect the hand of the user from accidentally coming into contact with the battery pack 75 and preventing the battery pack 75 from contacting the surface 70 if the cut-off saw 10 were to be dropped from a distance above the surface 70.

The saw 10 further includes a foot 18 positioned on a bottom portion of the housing 15 and extending in front of the motor 65 and behind the cutting wheel 25. In other words, when the saw 10 is placed on the work surface 70, the foot 18 is in contact with the work surface 70 and is configured to support the saw 10. The cut-off saw 10 further includes a protective plate 78 positioned forward of the foot 18 and coupled to a bottom side of the housing 15. The protective plate 78 generally includes three sides with a bottom side 78a contacting the surface 70. In other words, the protective plate is triangular-shaped. The protective plate 78 may be made out of a hard metal such as steel, aluminum, or the like. Together, the foot 18 and the protective plate 78 protect the motor 65 and the battery pack 75 from slurry ingress that may occur during operation or when the cut-off saw 10 is placed on the ground as will be discussed in more detail below.

With reference to FIG. 5, a cooling airflow is 84 is induced by a fan (not shown) coupled to the motor 65 for rotation therewith. The cooling airflow 84 is drawn in by the fan through inlet vents 88 on the rear handle 45. Specifically, the inlet vents 88 are positioned on a bottom side of the loop defined by the rear handle 45. The cooling airflow 84 is then drawn into the interior of the housing 15 and over the motor 65 and the circuit board 66. The cooling airflow 84 is then discharged radially by the fan through exhaust vents 90 in the foot 18 and back to the environment. The exhaust vents 90 are positioned rearward of the saw blade 25 and adjacent the protective plate 78 to further protect against slurry and other contaminants from being drawn into the housing 15. In other words, the protective plate 78 is positioned between the exhaust vents 90 and the cutting wheel 25. Additionally, the cooling airflow 84 blows dust and debris that may be heading the exhaust vents 90. The foot 18 of the housing 15, the support brackets 22a, 22b and the bottom side 78a of the protective plate 78 define a base of the cut-off saw 10 that contact the work surface 70 and support the cut-off saw 10. In addition, the battery receptacle 72 is defined by the foot 18, the inside surfaces of the support brackets 22a, 22b, and the bottom plate 68.

The battery pack 75 is removably coupled to a battery mount 80, which is positioned inside the battery receptacle 72 on an upper surface below the rear handle 45. The battery mount 80 includes parallel rails that are engageable with corresponding parallel grooves (not shown) defined in the battery pack 75 to mechanically interconnect the battery pack 75 to the battery receptacle 72. As such, the battery pack 75 may be inserted into the battery receptacle 72 in a direction that is parallel to the surface 70. In other embodiments, the battery pack 75 may be inserted into the battery receptacle 72 from below the housing in a direction perpendicular or orthogonal to the surface 70. The battery mount 80 also includes electrical terminals (not shown) that electrically connect with corresponding electrical terminals on the battery pack 75 during insertion of the battery pack 75 into the battery receptacle 72. The illustrated battery pack 75 is a power tool battery pack having a plurality of rechargeable battery cells (not shown). The battery cells may be lithium-based or have any other suitable chemistry.

As illustrated in FIG. 2, the trigger 50 may be a dual-activation trigger. In other words, the trigger 50 may include a lockout mechanism to prevent unwanted operation of the saw 10. The lockout mechanism may include a shuttle 265 sliding supported by the rear handle 45. A resilient member (not shown) may bias the shuttle 265 to a lockout position, in which the shuttle 265 prevents the trigger 50 from being depressed. A user may press one end of the shuttle 265 inward sliding from the lockout position to a use position. Once the shuttle 265 aligns with an outer surface of the handle 45, the trigger 50 may be depressed to activate the saw 10.

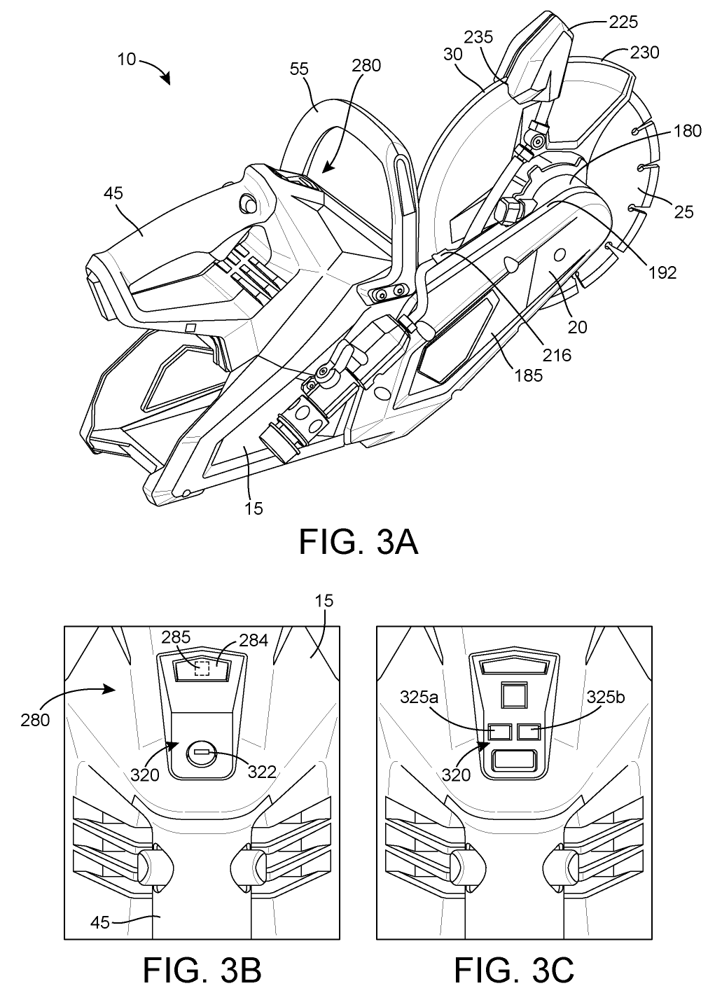

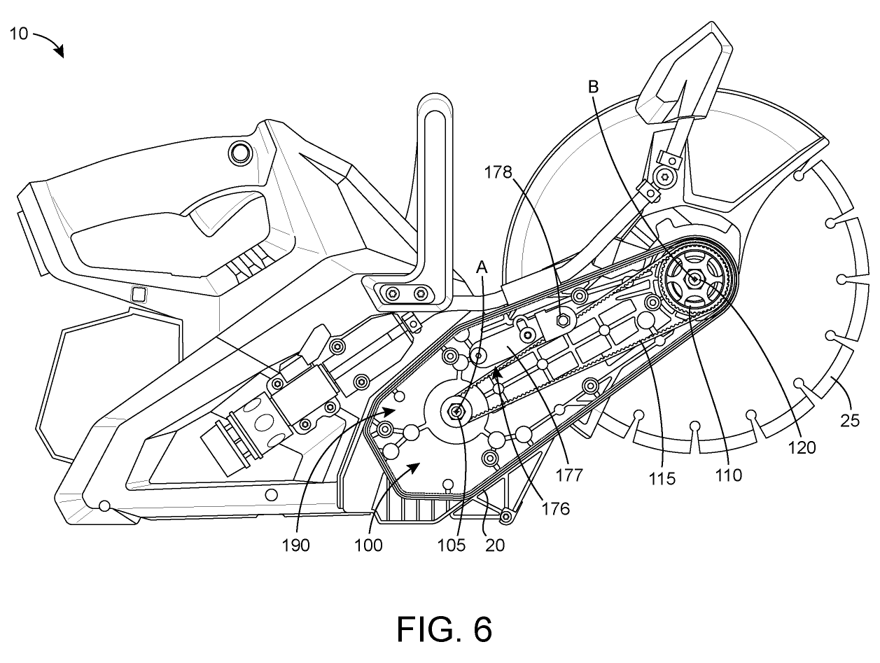

Referring to FIG. 3A, the support arm 20 includes a support portion 180 or arm body coupled to the housing 15 and a belt cover 185 coupled to the support portion 180. Together, the support portion 180 and the belt cover 185 define a chamber 190 (FIG. 6) in which the drive assembly 100 is disposed. In addition, the support portion 180 and the belt cover 185 abut to define a sealing surface 192. The sealing surface 192 prevents the ingress of debris and liquid from entering the chamber 190. In some embodiments, a gasket may be positioned on or adjacent the sealing surface 192 to further prevent environmental conditions such as water, dust, debris of the like access to the chamber 190. The belt cover 185 may be removably coupled to the support portion 180 with fasteners or the like. A user may loosen the fasteners and remove the belt cover 185 to allow access to the chamber 190 and the drive assembly 100.

Referring to FIG. 3B, the saw 10 includes a load indicator 280 to assist a user in operating the saw 10. The load indicator 280 is positioned on a top side of the housing 15 adjacent and in between the rear and forward handles 45, 55, as shown in FIG. 3A. In other embodiments, the indicator 280 may be positioned on other locations on the housing 15. Preferably, the load indicator 280 is positioned on the housing 15 within a line of sight of a user during operation of the saw 10. The load indicator 280 is configured to warn against excessive battery and or motor use (i.e., by measuring an amount of current being drawn from the battery pack 75 or other parameters such as current within the motor). In the illustrated embodiment, the load indicator 280 includes a clear lens 284 covering a light emitting diode 285 (“LED”) which is configured to change color (e.g., red, yellow, green, etc.) depending on how much power is being used so that the user can adjust their usage of the saw 10 without impacting the battery run-time of the saw 10. In other words, the LED 285 may be configured to change color depending on a current draw value. In some embodiments, the LED 285 may have predetermined threshold values at which the LED 285 changes colors. For example, when the current draw value reaches a first predetermined value, the LED 285 is configured to turn on from no light to a green light. Similarly, when the current draw value reaches a second predetermined threshold value, the LED 285 is configured to change from green to red or yellow. Accordingly, when a user operates the saw 10, the LED 285 is configured to illuminate based on the system performance of the saw 10. For example, when the LED 285 is green, the user will be aware that the saw 10 is at optimal performance. Accordingly, the user is coached to achieve and maintain optimal performance of the saw 10. Similarly, when the LED 285 is colored yellow or red, the user will be aware that the saw 10 is experiencing sub-optimal performance. In some embodiments, the LED 285 may pulse ON and OFF to provide further system performance indications to the user.

Additionally, in the present embodiment, the saw 10 may be configured to operate in two different modes (e.g., a concrete mode and a metal mode). For example, the load indicator 280 may be configured to turn on sooner from cutting concrete than cutting metal. In other words, the predetermined value of current draw when the saw 10 is in the concrete mode may be lower than the predetermined value of current draw when the saw 10 is in the metal mode to turn on the LED. The user may manually adjust the saw from the concrete mode to the metal mode via, for example, a user interface 320. In some embodiments, the user interface 320 includes an actuator 322 or button positioned adjacent the load indicator 280. In other embodiments, the user interface 320 may be any suitable actuator (e.g., a switch, dial, screen, etc.). As shown in FIG. 3C, in some embodiments, the user interface 320 may include indicia 325a, 325b that may be lighted by the LED 285 to indicate to the user which mode the of operation the cut-off saw is in. For example, the indicia 325a may be representative of a concrete workpiece to indicate the load indicator 280 is in concrete mode and the indicia 325b may be representative of a metal workpiece to indicate the load indicator 280 is in the metal mode.

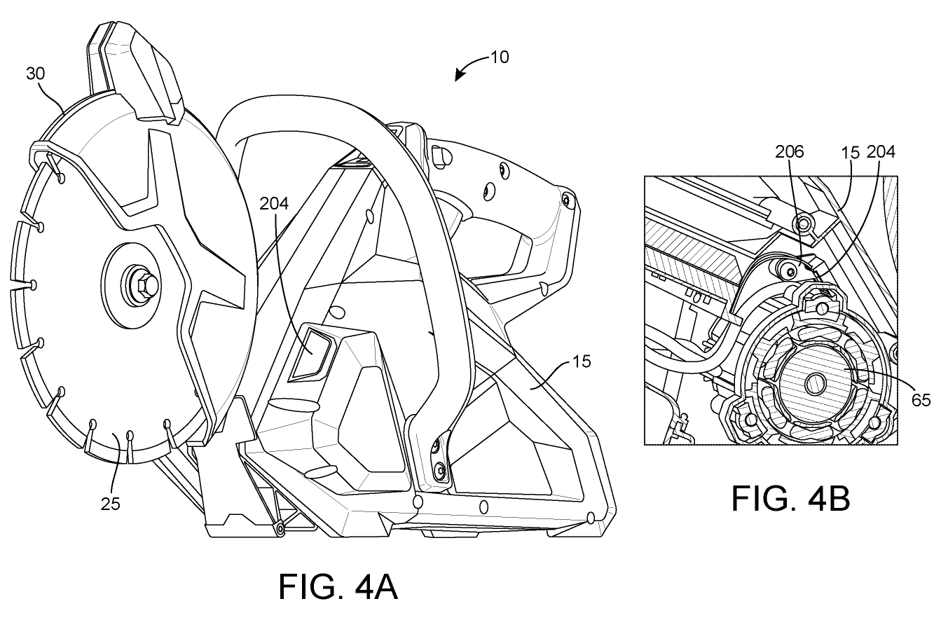

Referring to FIG. 4A, the saw 10 further includes a work light 204 configured to illuminate a workpiece during the cutting operation. For example, while the user is performing the cutting operation, the cut-off saw 10 may block overhead lighting, thereby obscuring the workpiece and cutting wheel 25. Accordingly, the work light 204 is positioned on a lower portion of the housing 15 facing the workpiece such that the workpiece and cutting wheel 25 are illuminated during the cutting operation. As shown in FIG. 4B, the work light 204 is supported within the housing 15 with a mount 206 having a bracket and fastener. The work light 204 includes a light (e.g., LED) that shines through a clear opening on the housing 15. The work light 204 may be actuated ON and OFF by the user. For example, the user interface 320 may include an actuator that can be toggled to turn the work light 204 ON and OFF. Alternatively, the work light 204 may be configured to turn ON when the saw 10 is powered on and brought near the workpiece. For example, the work light 204 may include a proximity sensor configured to detect the workpiece. Alternatively, the work light 204 may be activated whenever the motor is armed and the trigger 50 is depressed indicating a cutting operation.

As illustrated in FIG. 1, the saw 10 further includes a fluid distribution system 202 including a connector 205 coupled to the housing 15 and a distributor 215 coupled to the guard 30. A supply line (not shown) can be attached to the connector 205 to provide fluid such as water to the fluid distribution system 202 from an external source (not shown). The connector 205 may include a valve 207 to limit the distribution of fluids from the supply line to the fluid distribution system 202. The valve 207 may be an automated valve that automatically turns on when the motor 65 activates.

A first line 218, or hose, extends from the connector 205, along the support arm 20, and to the distributor 215. The support arm 20 includes a hose retainer configured to guide at least a portion of the first line 218. The hose retainer 216 is positioned on a rear side of the support portion 180 between the blade guard 30 and the belt cover 185. The hose retainer 216 defines a catch 219 that supports the first line 218. In the illustrated embodiment, the hose retainer 216 is integral with the support portion 210. In other embodiments, the retainer 216 may be a separate feature attachable to the support arm 20. The hose retainer 216 extends upwardly from the support arm 20 and forms a lip which surrounds the first line 218 on three sides. The hose retainer 216 is configured to guide the first line 218 from the connector 205 to the support arm 20. While in the present embodiment, the hose retainer 216 is a lip, in other embodiments, the hose retainer 216 may fully enclose the first line or instead be a recess configured to receive a portion of the first line 218. In yet other embodiments, the hose retainer 216 may be a separate clip configured to be attached to the support arm 20. Accordingly, the hose retainer 216 is configured to assist in positioning the first line 218 while maintaining a low profile. In other embodiments, the fluid distribution system 202 may be run completely outside of the housing 15 and the support arm 20 or may run through portions of the housing 15 and the support arm 20. In the illustrated embodiment, the connector 205 is directly coupled to the housing 15 with fasteners. In addition, a hose clamp 214 is coupled to the housing 15 adjacent the connector 205 to help guide the first line 218 to the distributor 215. In some embodiments, a single fastener may support the connector 205 and couples an upstream portion of the first line 218 to the housing 15. In further embodiments, more than one fastener may be used to couple the first line 218 to the housing 15 or support arm 20.

In the illustrated embodiment, the distributor 215 includes a pair of spray nozzles 220 disposed on opposite sides of the guard 30 connected by a supply line (not shown) that runs through a bracket. The spray nozzles 220 are operable to discharge fluid onto each side of the cutting wheel 25 for cooling, lubrication, and dust abatement. In the illustrated embodiment, the bracket 225 is an auxiliary handle that is attached to the guard 30 that can be grasped by a user to facilitate adjusting an angular position of the guard 30. However, the bracket 225 may alternatively be located elsewhere on the guard 30.

With reference to FIGS. 1 and 3A, the blade guard 30 also defines a ridge 230 or raised portion that extends circumferentially about a portion of the blade guard 30. The ridge 230 extends a small distance from the top side of the blade guard 30. The ridge 230 is received by an impression 235 in the bracket 225. Together, the ridge 230 and the impression 235 define a sight line 240 that is aligned with the cutting wheel 25. In other words, an imaginary line defined by the ridge 230 is parallel with the cutting wheel 25 in the cutting direction. Moreover, the sight line 240 is positioned aligned in a plane that dissects the cutting wheel 25 in half. As such, during a cutting operation, a user is able to envision where the cutting wheel 25 is cutting into the workpiece.

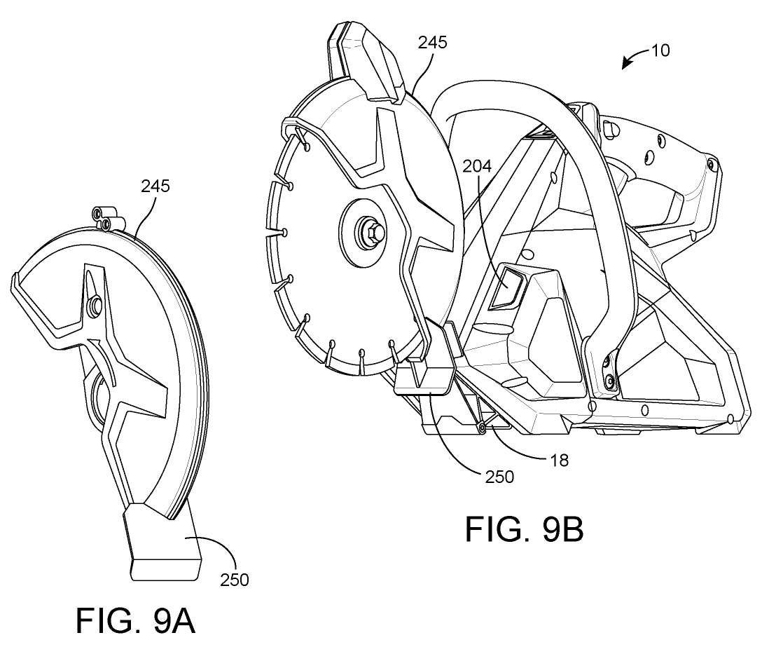

FIGS. 9A and 9B illustrate a blade guard 245 according to another embodiment. The blade guard 245 is similar to the blade guard 30 discussed above but further includes a splash guard 250 extending from the body to inhibit slurry and other contaminants from contacting the user during a cutting operation. The splash guard 250 is a portion of the blade guard 30 that extends from the remainer of the blade guard 30. In addition, the splash guard 250 includes a wider width in a direction parallel to the rotation axis B than a remainder of the blade guard 245. The splash guard 250 defines a curved front surface to block the slurry. The splash guard 250 is positioned in front of the foot 18 and below the work light 204 to prevent the splash guard 250 from blocking the work light 204. In the illustrated embodiment, the splash guard 250 is integral with the remainder of the blade guard 250. In other embodiments, the splash guard 250 may be a separate piece that is couplable to the housing 15 or other portion of the saw 10.

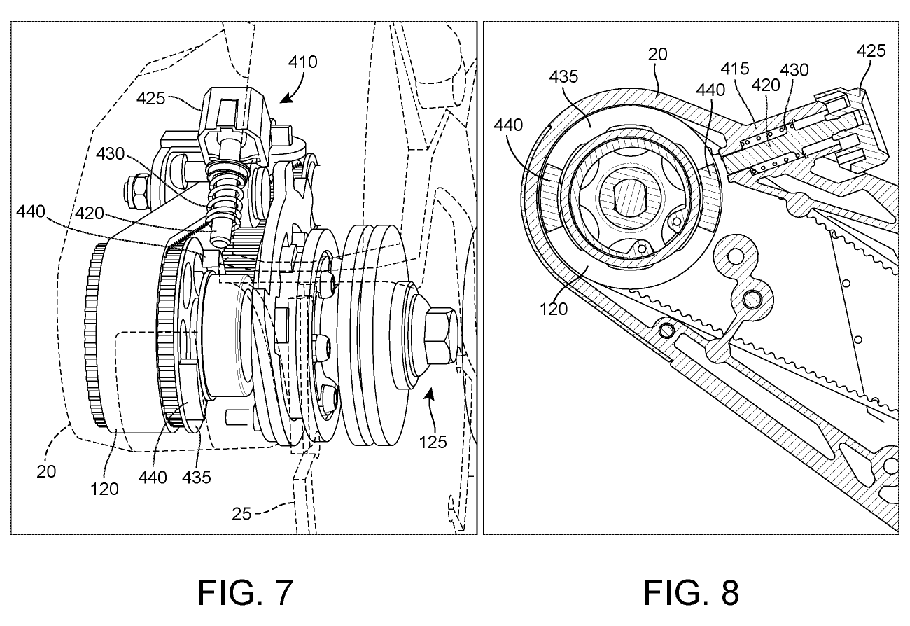

With reference to FIG. 6, the saw 10 includes a drive assembly 100 positioned in the support arm 20 for transmitting torque from the motor 65 to the cutting wheel 25. The drive assembly 100 includes a drive pulley 105 fixed to an output shaft of the motor 65, a driven pulley 110 connected to the drive pulley 105 by a belt 115, and a spindle 120 fixed to the driven pulley 110. The drive pulley 105 defines a first rotation axis A and the driven pulley 110 defines a second rotation axis B spaced from the first rotation axis A. In some embodiments, a clutch mechanism may be provided between the motor output shaft and the drive pulley 105 to selectively interrupt torque transfer between the motor output shaft and the drive pulley 105. The drive assembly 100 further includes a clamp assembly 125 (FIG. 7) configured to secure the cutting wheel 25 to the spindle 120. In the illustrated embodiment, the support arm 20 extends at an oblique angle with respect to the work surface 70. Specifically, a longitudinal line between intersecting both rotational axes A, B extends at an oblique angle to the work surface 70.

With continued reference to FIG. 6, the illustrated belt 115 is a synchronous belt having a plurality of teeth extending laterally across a width of the belt 115. The teeth are engageable with corresponding teeth on the driven pulley 110 and the drive pulley 105. The toothed engagement between the synchronous belt 115 and the pulleys 105, 110 prevents the belt 115 from slipping under high loads as may otherwise occur with a V-belt. In addition, the relatively flat profile of the synchronous belt 115 allows the drive pulley 105 to be smaller in diameter when compared with a v-belt configuration. As such, a higher reduction can be achieved between the drive pulley 105 and the driven pulley 110. For example, in some embodiments, the drive pulley 105 and the driven pulley 110 may be sized to provide a 4:1 reduction from the motor output shaft to the spindle 120. In other embodiments, the drive pulley 105 and the driven pulley 110 may be sized to provide between a 3:1 and a 5:1 reduction from the motor output shaft to the spindle 120.

This relatively high reduction ratio advantageously eliminates the need for a separate gearbox or gear reduction stage between the motor output shaft and the drive pulley 105, thereby improving mechanical efficiency and reducing the size, cost, and weight of the drive assembly 100. In the illustrated embodiment, the drive assembly 100 has a mechanical efficiency (i.e. a ratio of power at the spindle 120 to power at the output shaft of the motor) between about 95 percent and about 98 percent. In contrast, a drive assembly requiring a gearbox may have a mechanical efficiency of only about 92 percent or less. The relatively high reduction ratio also can allow the motor 65 to spin at a higher rate compared to V-belt and direct drive configurations, which can improve cooling and performance. In some embodiments, the motor 65 has a maximum output speed greater than 10,000 RPM. In other embodiments, the motor 65 has a maximum output speed between about 10,000 RPM and about 30,000 RPM. As such, the drive assembly 100 transfers rotation of the motor output shaft to the cutting wheel 25 to selectively rotate the cutting wheel 25 at up to 6,600 RPM. In the illustrated embodiment, the cutting wheel 25 rotates at a nominal speed of about 6,000 RPM at maximum performance while maintaining battery efficacy. In addition, the saw’s performance will remain relatively consistent over the lifetime of the belt 115. In contrast, V-belts typically stretch after a period of ordinary operation and must be manually or automatically tensioned from time to time to prevent slippage. As such, the drive assembly 100 may also include a belt tensioner 176 supported by the support arm 20. The belt tensioner 176 includes an extension arm 177 that is pivotable about a first end and a roller 178 coupled to the arm 177 at a second, opposite end. The roller 178 engages the belt 115 to relieve slack that may develop in the belt 115 over time. The belt tensioner 176 is adjustable to apply different amounts of tension to the belt 115 and keep it running tight around the drive and driven pulleys 105, 110.

With reference to FIGS. 7 and 8, a spindle lock 410 is supported by the support arm 20 to lock the spindle 120 in place to allow a user to apply torque to a fastener that secures the cutting wheel 25 to the spindle 120. The spindle lock includes a housing 415, a plunger 420 supported within the housing 415, a push button 425 coupled to the plunger 420, and a coil spring 430 that axially biases the plunger 420 away from a spindle disc 435. The spindle disc 435 may be referred to as a braking disc and is coupled to the spindle 120 and the driven pulley 110 for rotation therewith. The spindle disc 435 includes protrusions 440 extending radially about the spindle disc 435. In the illustrated embodiment, the spindle disc 435 includes two protrusions that are 180 degrees spaced about the rotation axis B. In other embodiments, the spindle disc may include more than two protrusions 440 that are equally spaced radially about the axis B. In order to prevent the spindle 120 from spinning when making a cutting wheel change, a user may depress the push button 425 which moves the plunger 420 into the path of the spindle disc 435. As a user rotates the cutting wheel 25, one of the protrusions 440 will engage the plunger 420 and prevent the spindle 120 from rotating allowing torque to be applied and releasing the cutting wheel 25.

In the illustrated embodiment, the bare cut-off saw 10 (i.e., without the battery pack 75 or the cutting wheel 25 attached) weighs between approximately 8 and 12 pounds. Preferably, the saw 10 without the battery pack 75 or the cutting wheel 25 weighs approximately 10 pounds. The saw 10 with the battery pack 75 and the cutting wheel 25 weighs between approximately 12 and 16 pounds. Preferably, the saw 10 with the battery pack 75 and the cutting wheel 25 weighs between approximately 14 and 15 pounds.

As shown in FIG. 1, the cut-off saw 10 defines an overall length L in a direction perpendicular to the rotation axes A, B between the most rearward part of the rear handle 45 and the most forward part of the cutting wheel 25. In the illustrated embodiment, the length L is between eighteen inches and 36 inches. In other embodiments, the length L may be between 20 inches and 30 inches. In further embodiments, the length L may be less than 18 inches or more than 36 inches. Therefore, in the illustrated embodiment, the cut-off saw 10 defines a length to weight ratio that is between 1.5 and 4.5. In other embodiments, the length to weight ratio may be between 1 and 5. In further embodiments, the length to weight ratio may be between 3 and 4.

The cut-off saw 10 advantageously provides more powerful cutting performance than other cut-off saws of a similar size. As such, the saw 10 may provide quicker cutting times than other saws. For example, the saw 10 may cut through 5/8-inch rebar in less than seven seconds. In some embodiments, the saw 10 may cut through 5/8-inch rebar in less than five seconds. Additionally, the saw 10 may to cut a 6-inch thick slab of concrete at full depth for a distance of 36 inches in less than 180 seconds. In other embodiments, the saw 10 may cut a 6-inch thick slab of concrete at full depth for a distance of 36 inches in less than 115 seconds. Another example, the saw 10 may cut concrete at a depth of 1 inch for a length of 36 inches in under 80 seconds. In further embodiments, the saw 10 may cut concrete at a depth of 1 inch for a length of 36 inches in under 60 seconds.

The drive assembly 100 of the saw 10 advantageously provides for quieter operation compared to typical cut-off saws having an internal combustion engine. Internal combustion engines ignite fuel in order to convert thermal energy into mechanical energy. As such, the ignition causes excessive noise. In addition, internal combustion engines are inherently imbalanced due to a reciprocating piston or pistons contained therein. This imbalance produces additional noise. The cut-off saw 10, which includes the brushless electric motor 65 and the battery pack 75 instead of an internal combustion engine, emits less noise than a typical cut-off saw having an equivalent power output because the internal combustion engine is eliminated. As such, the saw 10 may produce less than 100 dBa during operation and without any load. In some embodiments, the saw 10 produces less than 90 dBa during operation. In some embodiments, the saw 10 produces less than 80 dBa during operation.

The saw 10 also advantageously produces less vibration than typical cut-off saws having an internal combustion engine. As discussed above, internal combustions, due to inherent imbalance of reciprocating components, produces vibration. As such, the saw 10, which includes the brushless electric motor 65 and the battery pack 75 instead of an internal combustion engine, emits less vibration than a typical cut-off saw having an equivalent power output because the internal combustion engine is eliminated. For example, accelerometers were positioned on the saw 10 to measure the arm to hand vibration (HAV) at both the forward and rear handle 45, 55. The saw 10 may produce an average no-load HAV that is less than 3.0 m/s² at either or both the forward handle 55 and the rear handle 45. In other embodiments, the saw 10 may produce an average no-load HAV that is less than 2.5 m/s² at either or both the forward handle 55 and the rear handle 45. In some embodiments, the saw 10 may produce an average plunge cut (i.e., a cut where the saw blade is at full depth within a workpiece) HAV that is less than 3.5 m/s².

Although the invention has been described in detail with reference to certain preferred embodiments, variations and modifications exist within the scope and spirit of one or more independent aspects of the invention as described.

Various features of the disclosure are set forth in the following claims.

What is claimed is:

1. A cut-off saw comprising:
a housing including a base upon which the cut-off saw is positionable on a horizontal support surface;
an electric motor positioned within the housing;
a support arm extending in a forward direction from the housing, the support arm including a longitudinal axis defining an oblique angle with the horizontal support surface;
a cutting wheel supported by the support arm;
a rear handle extending in a rearward direction from the housing; and
a battery receptacle at least partially defined by the base and positioned behind the motor and beneath the rear handle, the battery receptacle configured to receive a battery pack.

2. The cut-off saw of claim 1, wherein the rear handle extends rearward of the battery pack when the battery pack is received in the battery receptacle.

3. The cut-off saw of claim 1, further comprising a forward handle that wraps around an upper portion of the housing.

4. The cut-off saw of claim 1, further comprising a battery pack configured to power the electric motor.

5. The cut-off saw of claim 4, wherein the battery pack is received in the battery receptacle in a direction parallel with the horizontal surface.

6. The cut-off saw of claim 1, wherein the battery receptacle is open to the environment and includes an open rear side.

7. The cut-off saw of claim 1, wherein the housing includes a foot positioned forward and beneath the motor and adjacent the battery receptacle.

8. A cut-off saw comprising:
a housing;
an electric motor positioned within the housing, the motor operable in a first mode and a second mode that is different than the first mode;
a battery pack operable to provide electrical current to the motor;
a cutting wheel driven by the motor to rotate about an axis; and
a load indicator operable to switch the motor between the first mode and the second mode, the load indicator operable to detect a performance parameter of the battery pack, the motor, or both, and indicate to a user with an indication that the performance parameter is above a predetermined threshold;
wherein the predetermined threshold is higher when the motor is in the first mode than when the motor is in the second mode.

9. The cut-off saw of claim 8, further comprising an controller electronically coupled to the battery pack, the motor, and the load indicator, wherein the controller is configured to:
determine a system performance based on the performance parameter, and
provide, using the indicator, an indication corresponding to the performance parameter.

10. The cut-off saw of claim 8, wherein the indication is a light emitting diode (LED).

11. The cut-off saw of claim 8, further comprising:
a rear handle extending from the housing; and
a forward handle wrapped around the housing.

12. The cut-off saw of claim 11, wherein the load indicator is positioned on the housing between the rear and forward handles.

13. The cut-off saw of claim 8, wherein the performance parameter is a current draw between the battery and the motor.

14. The cut-off saw of claim 8, wherein the load indicator includes an actuator to switch between the first and second modes.

15. A cut-off saw comprising:
a housing including a base;
an electric motor positioned within an interior of the housing;
a support arm coupled to and extending from the housing in a first direction;
a cutting wheel supported by the support arm;
a rear handle extending from the housing in an opposite, second direction;
an inlet vent defined by the housing and positioned adjacent the rear handle and in communication with the interior of the housing;
an exhaust vent defined by the housing positioned adjacent the motor and in communication with the interior of the housing; and
a protective plate positioned between the cutting wheel and the exhaust vent to inhibit the ingress of debris into the housing;
wherein in response to the activation of the motor a cooling airflow is induced through the inlet vent, through the motor, and discharged from the exhaust vent.

16. The cut-off saw of claim 15, wherein the protective plate is triangular.

17. The cut-off saw of claim 15, wherein the handle is a D-shaped handle, and wherein the inlet vents are positioned on a bottom side of the handle.

18. The cut-off saw of claim 15, wherein the exhaust vent is positioned on a bottom surface of the base.

19. The cut-off saw of claim 15, further comprising a circuit board positioned within the housing to control operation of the cut-off saw, the cooling airflow is induced over the circuit board.

20. The cut-off saw of claim 15, wherein the cooling airflow is discharged radially through the exhaust vent.

21. A cut-off saw comprising:
a housing;
an electric motor positioned within the housing;
a support arm coupled to and extending from the housing;
a cutting wheel rotatably supported by the support arm about a rotation axis; and
a blade guard covering a portion of an outer circumference of the cutting wheel, the blade guard including a body and a splash guard extending from the body.

22. The cut-off saw of claim 21, wherein the blade guard is rotatably coupled to the support arm.

23. The cut-off saw of claim 21, wherein the splash guard is wider than the body of the blade guard.

24. The cut-off saw of claim 21, wherein the splash guard defines a curved front surface.

25. The cut-off saw of claim 21, further comprising a protective plate coupled to a front of the housing.

26. The cut-off saw of claim 25, further comprising a work light supported by the housing, the splash guard positioned between the work light and the protective plate.

27. A cut-off saw comprising:
a housing;
an electric motor supported within the housing, the electric motor including an output shaft;
a support arm extending in a forward direction from the housing;
a cutting wheel supported by the support arm;
a drive assembly positioned in the support arm for transmitting torque from the motor to the cutting wheel, the drive assembly including,
a drive pulley fixed to the output shaft of the motor,
a driven pulley connected to the drive pulley by a belt, and
a spindle fixed to the driven pulley about an axis; and
a spindle lock supported on the support arm adjacent the spindle, the spindle lock moveable between a first position, in which the spindle is allowed to rotate and a second position, in which the spindle is inhibited from rotating.

28. The cut-off saw of claim 27, wherein the spindle lock includes a plunger and a braking disc supported by the spindle that engages the plunger to inhibit rotation of the spindle.

29. The cut-off saw of claim 28, wherein the braking disc includes protrusions to engage the plunger.

30. A cut-off saw comprising:
a housing;
an electric motor positioned within the housing;
a support arm coupled to and extending from the housing;
a cutting wheel supported by the support arm and configured to rotate about a rotational axis; and
a blade guard supported by the support arm and covering a portion of an outer circumference of the cutting wheel, the blade guard including an upper surface defining a ridge extending circumferentially about a portion of the blade guard, the ridge being aligned with the cutting wheel to provide a sight line during a cutting operation.

31. The cut-off saw of claim 30, further comprising a bracket supported by the blade guard, the bracket including an impression to receive the ridge, the ridge and the impression provide a sight line during a cutting operation.

32. The cut-off saw of claim 31, wherein the bracket supports spray nozzles of a fluid distribution system.

33. The cut-off saw of claim 31, wherein the bracket defines an auxiliary grip that can be grasped by a user.

34. The cut-off saw of claim 30, wherein the sight line extends in a direction perpendicular to the rotational axis.

35. The cut-off saw of claim 30, wherein the ridge and the cutting wheel are aligned in a plane that dissects the cutting wheel and blade guard.

36. A cut-off saw comprising:
a housing;
an electric motor positioned within the housing;
a support arm extending from the housing;
a cutting wheel supported by the support arm;
a blade guard coupled to the support arm to cover a circumferential portion of the cutting wheel;
a fluid distribution system operable to dispense fluid onto the cutting wheel, the fluid distribution system including a valve coupled to the housing, a nozzle coupled to the blade guard, and a supply line extending between the valve and the nozzle; and
a bracket extending from the support arm through which a portion of the supply line extends to secure the supply line to the support arm.

37. The cut-off saw of claim 36, wherein the bracket is positioned on a rear of the support arm.

38. The cut-off saw of claim 36, further comprising a drive assembly including a drive pulley and a driven pulley connected to the drive pulley with a synchronous belt.

39. The cut-off saw of claim 38, wherein the support arm includes an arm body coupled to the housing and a belt cover coupled to the arm body, wherein the bracket is integral with the arm body.

40. The cut-off saw of claim 39, wherein the arm body and the belt cover define a chamber, and wherein the drive assembly is disposed within the chamber.
